(19) United States
(12) Patent Application Publication
(10) Pub. No.: US 2003/0093472 A1
(43) Pub. Date: May 15, 2003

(54) Project management system and method

(76) Inventor: R. Paul Warren, Baltimore, MD (US)

Correspondence Address: MATTINGLY, STANGER & MALUR, P.C., 1800 DIAGONAL ROAD, SUITE 370, ALEXANDRIA, VA, 22314, US

(21) Appl. No.: 10/284,156

(22) Filed: Oct. 31, 2002

Related U.S. Application Data
(60) Provisional application No. 60/330,774, filed on Oct. 31, 2001.

(51) Int. Cl. G06F 15/16

(52) U.S. Cl. 709/203

(57) ABSTRACT

A project management system enables a project managing entity to monitor the status of a project requiring various activities to be performed by multiple participants. The performance of each activity is tracked by entering data from the participants and a standard data entry format that is sent from a web client to a web server over a network, such as the Internet. The entered data are compared and verified to determine whether they comply with rules for an individual participant's internal accounting system. If compliant, the data are entered into a database connected to the web server.

Data stored in the database are used to generate project management reports. Also, data are retrieved from the database and translated by the web server to provide data output to individual participants in a format that complies with the internal counting system of each participant.

### CROSS REFERENCE TO RELATED APPLICATIONS

I claim benefit under Title 35, United States Code, §120 to U.S. Provisional Application No. 60/330,774, filed Oct. 31, 2001, entitled PROJECT MANAGEMENT SYSTEM AND METHOD.

### BACKGROUND OF THE INVENTION

1. Field of the Invention

This invention relates to a project management system and a method with time tracking for managing projects having multiple stakeholders or parties interested in the performance and progress of the project.

### DESCRIPTION OF RELATED ART

The management of a project that involves multiple participants in the project or “stakeholders” and an integration of the performance of many activities over time requires monitoring the status of each activity as it is performed by each stakeholder. Such monitoring may include the progress level and expenses associated with each activity.

As the project progresses, the management of the project requires an accounting for time and expenses involved, preferably on a daily basis for each stakeholder.

Existing accounting systems can efficiently track the performance of activities associated with one company, however such accounting systems are unable to adequately monitor the status of the performance of a number of activities performed by multiple stakeholders, such as contractors and venders working together on a project. The primary reason for this inability is that the differences among the accounting systems of the various stakeholders make it difficult to integrate the data associated with the accounting of the time input by employees and the expenses associated with the activities. Further, the data that is input into the project management system needs to be stored in a standardized format from which reports can be generated on a daily basis.

### BRIEF SUMMARY OF THE INVENTION

The invention is a project management system. The project management system includes a web server. The web server is responsive to at least one web client or participant. The web participant communicates with the web server through a known communication protocol. The project management system also includes a plurality of active server pages that are served by the web server to the web participant. The plurality of active server pages generates a common web interface and prompts at least one participant or a plurality of participants to input data through the common web interface. The project management system has a project management program for validating data input by each participant and for converting the inputted data to a standard data format. A project management database is included for storing the inputted data of each participant in the standard data format. A project data retrieval program for converting the stored data of each participant from the standard data format to a client-specific format is included and allows each participant to access and retrieve the stored data of the respective participant in both the standardized data format and the participant-specific format, and allows a project manager to access, retrieve, and process the stored data of each participant.

The invention is also a method for monitoring a project involving at least one participant or a plurality of participants. The method includes serving a plurality of active server pages by a web server to at least one web participant. Then, prompting at least one participant to input data through the active server pages occurs. Validating the inputted data of each client and converting the inputted data of each client to a standard data format are performed. The method includes storing the inputted data of each participant in the standard data format, converting the stored data of each participant from the standard data format to a participant-specific format, allowing each participant to access and retrieve the stored data of the respective participant in both the standardized data format and the participant-specific format, and allowing a project manager to access, retrieve, and process the stored data of the plurality of participants.

One object of the invention is to provide a project management system and a method that enables a project managing entity, such as a project manager, to monitor the status of a project that requires various activities to be performed by multiple stakeholders.

Another object of the invention is to track multiple stakeholders involved in a project by monitoring the performance of each activity from data that is input in a standard data entry format by each stakeholder through the use of a data entry format template displayed on a display screen of a terminal device connected to a project management database over a computer network, such as the Internet. Preferably, actual time information and actual expense information related to each activity is collected on a daily basis from each respective stakeholder.

An additional object of the invention is to enable the project managing entity to monitor the progress of each activity of a project. The data input into the project management database is processed so that reports can be generated on a regular basis, such as a daily or monthly basis.

An additional object of the invention is to enable multiple stakeholders to input data regarding the performance of each activity into a standard data entry format over a computer network, such as the Internet, irrespective of each stakeholder=s internal accounting system, and to receive from the project management database accounting information that is in the format required by the stakeholder=s internal accounting system. In this way, the individual stakeholder may enter accounting data, such as time and expense data, through a standardized format for data entry into the database and receive the data that is entered by a return communication from the project management database or project manager in a form suitable for entry into the stakeholder=s respective internal accounting system.

An additional object of the invention is to enable each stakeholder to enter data through a data input template that is Arules tested@ to ensure that the input data are in a format required for acceptance by the internal accounting system of the stakeholder entering the data. Since the data are entered through a template, the data are in a form that is acceptable and compatible with the project management database used by the project manager. However, the data being input must also have sufficient specificity to be acceptable for the stakeholder's internal accounting system. This obviates the requirement for double entry of the data into the project management system and the stakeholder's internal accounting system.

### BRIEF DESCRIPTION OF THE DRAWINGS

The above and other objects and advantages of the invention will become more apparent by describing in detail preferred embodiments thereof with reference to the attached drawings of which:

FIG. 1 shows a block diagram of the system architecture of the project management system according to a preferred embodiment of the present invention;

FIGS. 2A and 2B show two diagrams of a common web interface residing at a client server of the project management system shown in FIG. 1; and

FIG. 3 shows a data flow diagram illustrating data entry, data validation and translation, data storage and data retrieval in the project management system shown in FIG. 1 according to the project management method of the present invention.

### DETAILED DESCRIPTION OF THE INVENTION

In accordance with the project management system and the method of the invention, a project management entity, such as a project manager, can work with multiple stakeholders, such as contractors, subcontractors, venders, funding sources or financial institutions, and agencies on large and small projects requiring the collaborative effort of the multiple stakeholders. A problem with monitoring projects involving multiple stakeholders is that the accounting systems of each stakeholder is likely to be different. Further, the employees of the respective stakeholders are instructed by their employer to enter data according to certain rules and conditions governed by internal guidelines and requirements regarding employee time reports and expense reports.

The users of the project management system are prompted to input data through a template displayed at a terminal or computer that is connected to, for example, the Internet, an intranet, or a LAN, in order to comply with the project manager's requirement for data entry and acquire a uniform set of data in the project management database so that reports may be generated. The project management database is able to output data from the project management database in a form suitable for each stakeholder's internal accounting system in order to prevent the data from having to be entered a second time. This is accomplished, according to a preferred embodiment of the present invention, as follows.

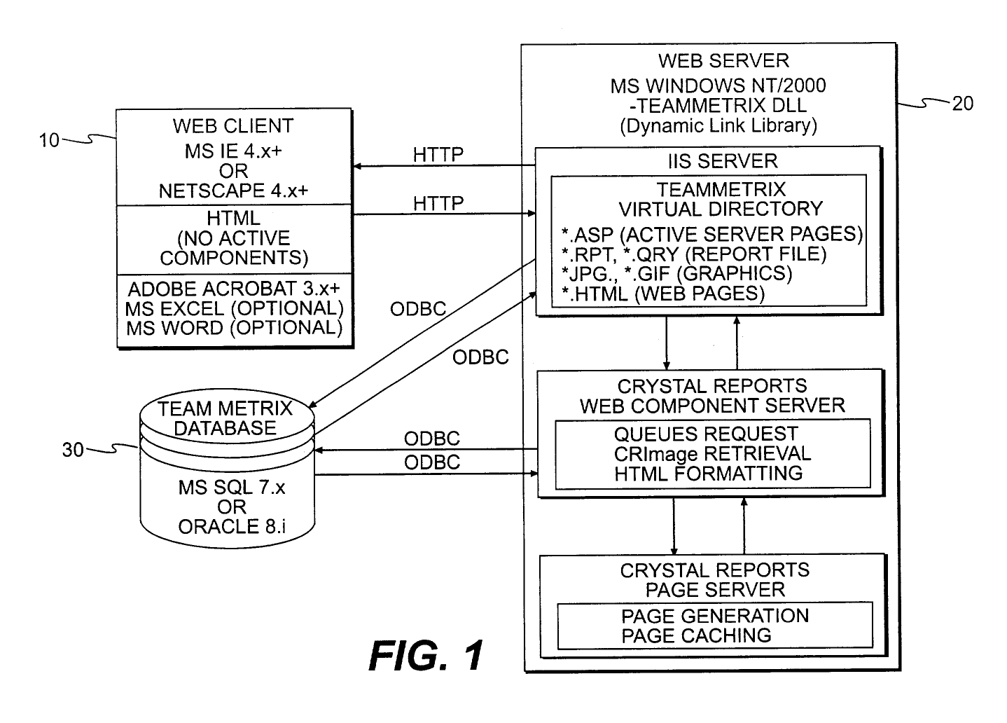

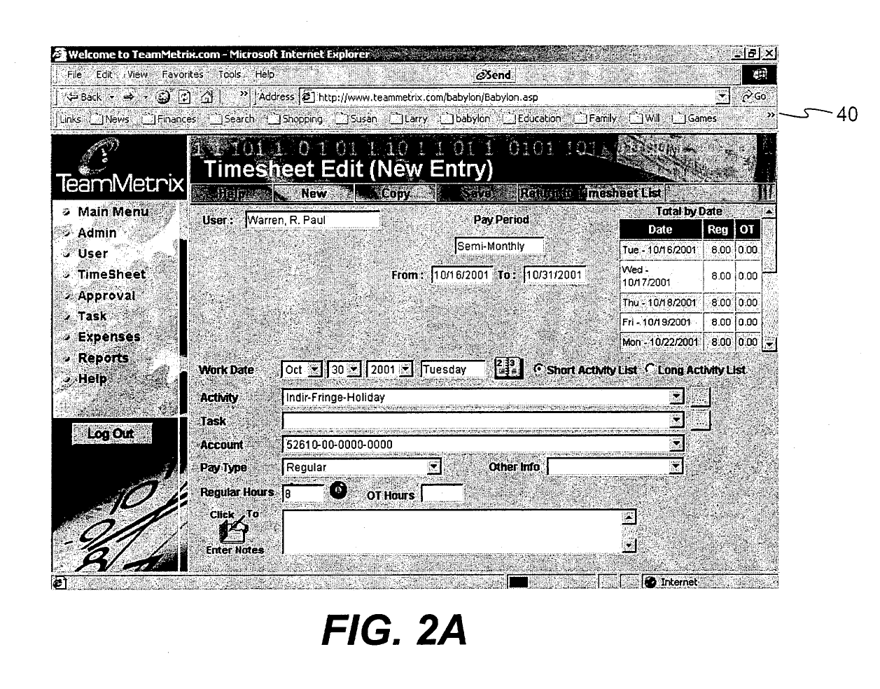

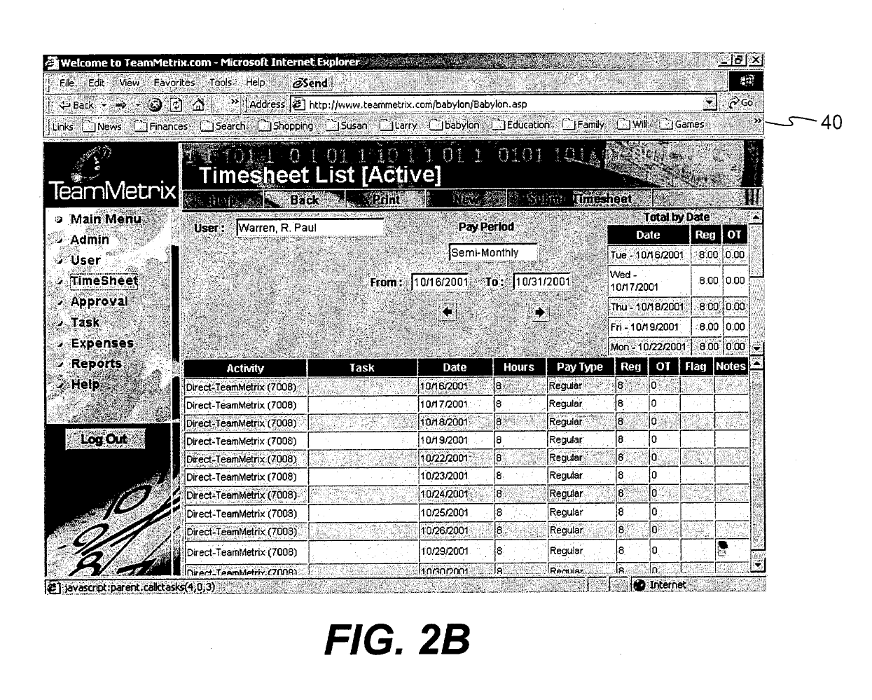

As shown in FIG. 1, a web client 10 is connected to a web server 20 over the Internet. The web client 10 and web server 20 preferably communicate through a known communication protocol such as HTTP. The web client 10 is, for example, a personal computer or terminal running a commercially available web browser such as those sold under the trade names Microsoft Internet Explorer or Netscape with Adobe Acrobat. Web server 20, for example, is an Internet server supporting a commercially available server platform such as that sold under the trade name Microsoft Windows NT/2000. The web server 20 is connected to a project management database 30 through an open database connectivity server (ODBC), which may be part of or separate from the web server 20. The project management database 30 is a database software application that runs on the web server 20. Examples of such a database software application are sold under the trade names Microsoft SQL or Oracle. The web server 20 has crystal reports software, according to a preferred embodiment of the invention. Also, web server 20 serves active server pages over the Internet to the web client 10. The active server pages generate a common web interface on the web client 10. Two such pages are shown as a preferred embodiment of the invention and include a display of a time sheet edit and a time sheet list in FIGS. 2A and 2B.

The common web interface provides a standard format through which data are entered by a stakeholder at a web client 10 of the system. Functions performed through the common web interface include administration functions such as a charting of accounts mapping, adding and/or editing users, and adding and/or editing corporate rules. The common web interface also provides user functions such as an entering time for an employee or employees of the stakeholder. For example, the time sheet edit display page shown in FIG. 2A enables a stakeholder to enter a new employee and edit the details of an employee's file. Also, the time sheet list display page shown in FIG. 2B enables a stakeholder to enter time and labor details as prompted by the display fields.

Different levels of access can be assigned to common web interface of the project management system. A first level of access provides system administration functions through which full rights of access to the project management system are permitted. The first level of access is usually provided to the program manager. In a second level of access, corporate administrative functions such as mapping accounts, adding and/or editing users, and adding and/or editing corporate rules, are permitted. In a third level of access, supervisory administrative functions such as approvals for expenses and adding and/or assigning tasks, are permitted. In a fourth level of access, user functions such as the entry of data on a time sheet list display page and the entry of data for vouchers, are permitted. In a fifth level of access, client functions such as downloading data from the project management database 30 and downloading confidential reports, are permitted. The fifth level is typically provided to an interested party which may not have a need to otherwise input data into the database.

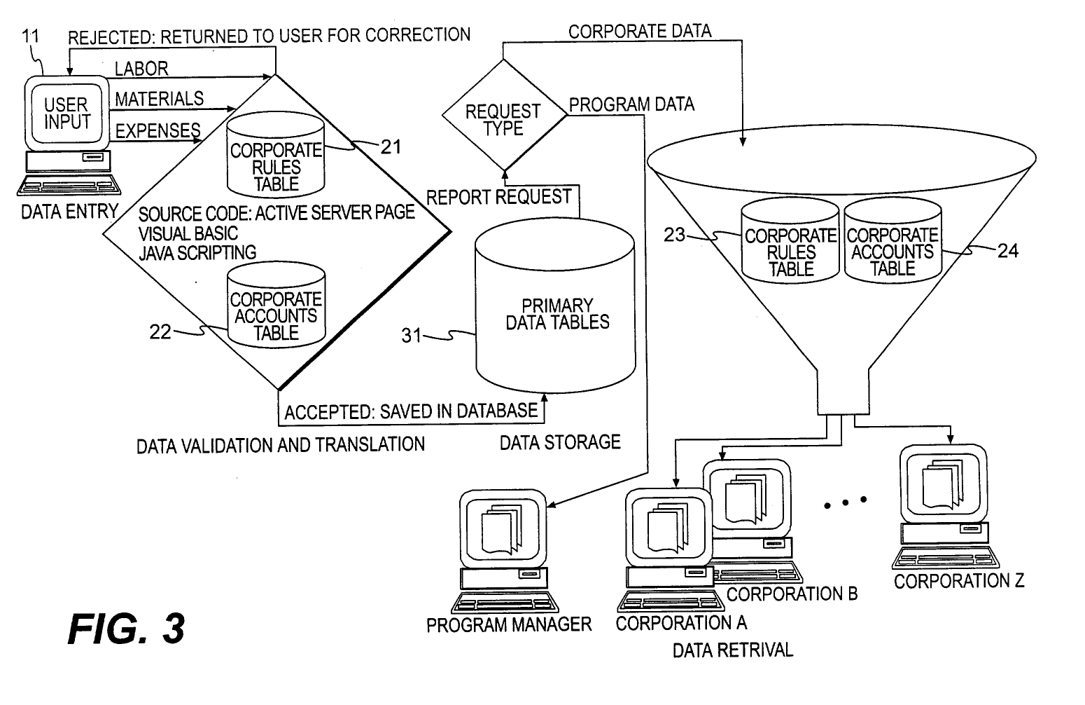

FIG. 3 shows a data flow diagram of the project management system and a method of the invention. Users input data in a standard data format through use of the common web interface 40 as shown in FIGS. 2A and 2B at a web client terminal 11. Typical data that are entered by the user includes labor details such as daily time reports, sick leave, and vacation reports; materials used on the project; and expense reports.

Data that are entered through the web client terminal 11 are subjected to a validation at the web server 20 through, for example, a reference table or corporate rules table 21. The reference parameters or “corporate rules” are applied to the entered data for validation. The rules are specific to each stakeholder for example, corporations A, B, . . . Z. Generally, different corporations have different internal accounting systems and therefore have different corporate rules for entering data related to labor, materials, and expenses. For example, time sheet data for corporation A can be collected in increments to the nearest tenth of an hour (six minutes), whereas time sheet data for corporation B can be collected in increments of one sixth of an hour (10 minutes). When a user enters data through the common web interface for a particular stakeholder or corporation in this example, the corporate rules table 21 is used to validate the entered data. If the entered data are not consistent with the corporate rules table 21, i.e., in a suitable increment of time for the entry of time sheet list data, then the data are rejected. Rejected data are immediately returned to the user through a server page with a message to input the data in a manner consistent with the corporate rules for that particular client, participant, or “stakeholder.”

If the data pass validation of the corporate rules table 21, then the data are translated by a translator or corporate accounts table 22 and stored in a primary data table 31 in the project management database 30 as shown in FIG. 1. The translation of data through the corporate accounts table 22 ensures that a uniform chart of accounts is used to represent the entered data in the primary data table 31.

Once the primary data table 31 is constructed or updated with data input by a user, and the data have been validated and translated, the program manager is able to access the data and generate the reports pertaining to the status of the various activities performed in connection with the project being managed. Through the program manager computer, standard data input from all of the stakeholders can be correlated and reported for use in monitoring and tracking the activities.

According to the preferred embodiment of the project management system of the invention, the data input by a user through the web client 10 or web client terminal 11 is also available to be retrieved by each individual stakeholder, such as corporations A, B, etc. In this regard, the corporate data are retrieved, as shown in FIG. 3, from the primary data table 31 and are converted back into data that are in the required format for the internal accounting system of each stakeholder. In this regard, the parameters or corporate rules applied to the data through the corporate rules table 23 convert the data into a form that is required by the internal accounting system of that stakeholder, for example, the proper increment of time to be reported through a time sheet report. Further, the corporate accounts table 24 is used to insure that the data are matched with the appropriate account for that stakeholder. The corporate rules table 23 and the corporate accounts table 24 are applicable to each report request for each specific corporation or stakeholder, i.e. corporations A-Z. In this manner, it is unnecessary for a user or stakeholder to input data for use in the project management system in one format and then reenter the data in another format as required by that user's internal accounting system for the particular corporation. Further, the project manager is able to store and retrieve data in the monitoring of the various activities of the multiple stakeholders in real time by accessing the data in the primary data table 31.

By the present invention, there is no need to wait for invoices or monthly reports to be received from multiple stakeholders to know the progress of a project and how the stakeholders in the project are performing on the various activities. The system enables the project manager to accurately determine how much time and money has been spent on each and every phase of the project by merely accessing the database. Further, since the project manager and the contractors share the same data, it is unnecessary to engage in dialog about different formats for entering hours, billing codes, billing procedures, and billing errors. As a result, the project management system and method of the invention enable the project manager to monitor costs and performance on a daily basis throughout the life of a project, including tracking multiple stakeholders or vendors, by monitoring their progress and generating real time reports on their status. Further, since the project management system and method of the invention are web-based, web-delivered, and browser independent, implementing the project management system only requires “logging on” to a web site with a system that supports a server running a program, such as that sold under the trade name Windows NT/2000 and a MS SQL server or Oracle database.

While preferred embodiments have been set forth with specific details, further embodiments, modifications and variations are contemplated according to the broader aspects of the present invention, all as determined by the spirit and scope of the following claims.

I claim:

1. A project management system comprising:
a web server;
at least one web client, wherein the web client communicates with the web server through a known communication protocol;
a plurality of active server pages that are served by the web server to the web client, wherein the plurality of active server pages generate a common web interface and prompt at least one client to input data through the common web interface;
a project management program for validating data input by each client and for converting the inputted data to a standard data format;
a project management database for storing the inputted data of each client in the standard data format;
a project data retrieval program for converting the stored data of each client from the standard data format to a client-specific format, for allowing each client to access and retrieve the stored data of the respective client in both the standardized data format and the client-specific format, and for allowing a project manager to access, retrieve, and process the stored data of each client.

2. The project management system of claim 1, wherein the project management program comprises:
a first corporate rules table for comparing the inputted data to a predetermined set of rules for each client, wherein the project management program rejects the inputted data that are inconsistent with the first corporate rules table and accepts the inputted data that are consistent with the first corporate rules table; and
a first corporate accounts table for converting the accepted data of each client to the standard data format.

3. The project management system of claim 2, wherein the project management database comprises a primary data table for storing the accepted data of each client in the standard data format.

4. The project management system of claim 3, wherein the project data retrieval program comprises:
a second corporate rules table for converting the stored data of each client from the standard data format to a client-specific format;
a second corporate accounts table for allowing each client to access and retrieve the stored data of the respective client in both the standardized data format and the client-specific format.

5. The project management system of claim 1, further comprising a plurality of access levels.

6. The project management system of claim 5, wherein the plurality of access levels comprises a first level of access providing system administration functions, wherein a full right of access to the project management system is permitted;
a second level of access providing corporate administrative functions, wherein the rights to account mapping, adding and/or editing users, and adding and/or editing corporate rules are permitted;
a third level of access providing supervisory administrative functions, wherein the rights to approvals for expenses and adding and/or assigning tasks are permitted;
a fourth level of access providing user functions, wherein the right to input data is permitted; and
a fifth level of access providing client functions, wherein the right to download data from the project management system is permitted.

7. A method for monitoring a project involving at least one client comprising the steps of:
serving a plurality of active server pages by a web server to at least one web client;
prompting at least one client to input data through the active server pages;
validating the inputted data of each client;
converting the inputted data of each client to a standard data format;
storing the inputted data of each client in the standard data format;
converting the stored data of each client from the standard data format to a client-specific format;
allowing each client to access and retrieve the stored data of the respective client in both the standardized data format and the client-specific format; and
allowing a project manager to access, retrieve, and process the stored data of the plurality of clients.

8. The method of claim 7, wherein the step of validating the inputted data of each client comprises:
comparing the inputted data to a predetermined set of rules for each client to a first corporate rules table;
rejecting the inputted data that are inconsistent with the first corporate rules table; and
accepting the inputted data that are consistent with the first corporate rules table.

9. The method of claim 7, wherein the step of converting the accepted data of each client to the standard data format comprises using a first corporate accounts table.

10. The method of claim 7, wherein the step of storing comprises using a primary data table to store the accepted data of each client in the standard data format.

11. The method of claim 7, wherein the step of allowing each client to access and retrieve the stored data of the respective client comprises:
using a second corporate rules table for converting the stored data of each client from the standard data format to a client-specific format; and
using a second corporate accounts table for allowing each client to access and retrieve the stored data of the respective client in both the standardized data format and the client-specific format.

12. The method of claim 7, further comprising permitting a plurality of access levels.

13. The method of claim 12, wherein the step of permitting the plurality of access levels comprises:
providing system administration functions through a first level of access, wherein a full right of access to the project management system is permitted;
providing corporate administrative functions through a second level of access, wherein the rights to account mapping, adding and/or editing users, and adding and/or editing corporate rules are permitted;
providing supervisory administrative functions through a third level of access, wherein the rights to approvals for expenses and adding and/or assigning tasks are permitted;
providing user functions through a fourth level of access, wherein the right to input data is permitted; and
providing client functions through a fifth level of access, wherein the right to download data from the project management system is permitted.
